(19) United States
(12) Patent Application Publication
(10) Pub. No.: US 2026/0365861 A1
(43) Pub. Date: Nov. 19, 2026

(54) ANTI-STATIC COATING SYSTEM

(71) Applicant: SIKA TECHNOLOGY AG, Baar (CH)

(72) Inventors: Christian BRUCHERTSEIFER, Tecklenburg (DE); Dirk SEEGER, Oldenburg (DE); Burkhard WALTHER, Taching am See (DE)

(73) Assignee: SIKA TECHNOLOGY AG, Baar (CH)

(21) Appl. No.: 19/115,503

(22) PCT Filed: Nov. 6, 2023
(86) PCT No.: PCT/EP2023/080890

§ 371 Date: Mar. 26, 2025

(30) Foreign Application Priority Data
Nov. 4, 2022 (EP) 22205635.0

(51) Int. Cl. C09D 5/24; C08G 18/72; C08G 18/76; C08G 18/79; C08K 3/04; C09D 5/02; C09D 7/61; C09D 175/04

(52) U.S. Cl. CPC C09D 5/24; C08G 18/721; C08G 18/7671; C08G 18/797; C09D 5/022; C09D 5/028; C09D 7/61; C09D 175/04; C08K 3/041; C08K 2201/001; C08K 2201/011

(57) ABSTRACT

A coating system which includes a part (A) including at least one polyol bearing two or more hydroxy groups, and a part (B) including at least one isocyanate bearing two or more isocyanate groups and including carbon nanotubes, wherein parts (A) and (B) are physically separated from each other, and wherein a coating produced by mixing parts (A) and (B) has an electrical resistance of ≤80 kΩ, measured according to DIN EN 61340-4-1:2016-04, and a bond strength of ≥1.5 MPa, measured according to DIN EN 1542:1999-07.

### FIELD OF THE INVENTION

The invention relates to anti-static coating systems, to coatings prepared from such systems to uses of such coating systems, and to coating methods.

### BACKGROUND OF THE INVENTION

In the building industry, surfaces and especially concrete surfaces often require a coating in order to provide desired surface properties. For example, in harsh chemical environments such as sewers and storage tanks in process industry coatings providing chemical resistance are regularly required. However, especially in the process industry the need for antic-static properties of coating systems and coatings made therefrom, respectively, has increased over the last decade. Here, anti-static means that electrostatic discharge is reduced, dampened or otherwise inhibited. Antic-static properties are in particular desirable in the context of handling flammable substances to avoid that electrostatic charges ignite such flammable substances. However, many known coating systems such as epoxide systems and polyurethane systems fail to provide coatings which are sufficiently anti-static.

In order to provide coating systems with anti-static properties, the incorporation of conductive fibres like carbon fibres, conductive polymer fibres and carbon nanotubes (CNTs) into such systems has been contemplated, for example in EP 3 670 470 A1. The use of CNTs in coating systems has recently been considered in various respects (see for example CN 108219658 A, CN 111808464, CN 112852269 A, US 2022/0056277 A1, WO 2022/049070 A1, and WO 2022/049071 A1). However, the described systems may at least partially not lead to coatings which are anti-static enough in order to avoid an ignition of flammable substance. Moreover, it is known from for example EP 2 315 810 B1 that CNTs often show a disadvantageously low dispersibility when being incorporated into coating systems, and that the processing viscosity is often disadvantageously high.

Furthermore, the known coating systems often lead to coatings which have inferior adhesion and are thus prone to delamination. This is in particular a problem when a coating formed from such coating systems shall act as a diffusion barrier to protect a substrate on which they are formed. Hence, regularly another diffusion barrier layer is required in order to provide antic-static properties and also diffusion barrier properties to a substrate, especially to a concrete substrate.

Overall, there remains a general desire for improved anti-static coating systems.

### Problem Underlying the Invention

It is an object of the present invention to provide a coating system which at least partially overcomes the drawbacks encountered in the art.

It is a further object of the present invention to provide a coating system which can form a coating having improved anti-static properties as well as improved adhesion to a substrate, in particular to a concrete substrate.

It is an additional object of the present invention to provide a coating system in which carbon nanotubes can be distributed more uniformly and/or at reduced processing viscosity.

It is moreover an object of the present invention to provide a coating system which is cost efficient.

It is also an object of the present invention to provide a coating, a use thereof and a coating method, respectively, which at least partially overcomes the drawbacks encountered in the art.

### DISCLOSURE OF THE INVENTION

Surprisingly, it was found that the problem underlying the invention is overcome by coating systems, coatings, uses and coating methods according to the claims. Further embodiments of the invention are outlined throughout the description.

Subject of the invention is a coating system, comprising:
a part (A) comprising at least one polyol bearing two or more hydroxy groups, and
a part (B) comprising at least one isocyanate bearing two or more isocyanate groups and comprising carbon nanotubes,
   wherein parts (A) and (B) are physically separated from each other, and
   wherein a coating produced by mixing parts (A) and (B) has
      an electrical resistance of ≤80 kΩ, measured according to DIN EN 61340-4-1:2016-04, and
      a bond strength of ≥1.5 MPa, measured according to DIN EN 1542:1999-07.

As used herein, a polyol is to be understood in the usual skilled manner, i.e., as an organic compound bearing, or having, two or more hydroxy groups (≥2 OH groups). It is preferred that the polyol is selected from 1,2-ethanediol or ethylene glycol, 1,2-propanediol or 1,2-propylene glycol, 1,3-propanediol or 1,3-propylene glycol, 1,4-butanediol or 1,4-butylene glycol, 1,6-hexanediol or 1,6-hexamethylene glycol, 2-methyl-1,3-propanediol, 2,2-dimethyl-1,3-propanediol or neopentyl glycol, 1,4-bis(hydroxymethyl)cyclohexane or cyclohexanedimethanol, 1,2,3-propanetriol or glycerol, 2-hydroxymethyl-2-methyl-1,3-propanediol or trimethylolethane, 2-ethyl-2-hydroxymethyl-1,3-propanediol or trimethylolpropane, 2,2-bis(hydroxymethyl)-1,3-propanediol or pentaerythritol, or mixtures thereof. Particularly preferred is 1,4-butanediol. It is further preferred that the polyol is selected from polyether polyols, especially polymer-analogous polyether polyols, which regularly bear two or more hydroxy groups (≥2 OH groups), i.e., which have a functionality of ≥2. It is also contemplated that a preferred polyol is selected from polyols having a polyester backbone or a polybutadiene backbone, which polyols again regularly bear two or more hydroxy groups (≥2 OH groups).

As used herein, an isocyanate is to be understood in the usual manner in the technical field of organic chemistry, i.e., as an organic compound bearing, or having, an isocyanate group (—N═C═O group). The at least one isocyanate in part (B) of a coating system according to the present invention bears two or more isocyanate groups (≥2 —N═C═O groups). It is preferred that the isocyanate bearing 2 or more isocyanate groups is selected from tolylene 2,4-diisocyanate (also known as toluene 2,4-diisocyanate), tolylene 2,6-diisocyanate (toluene 2,6-diisocyanate), a mixture of these isomers (TDI), diphenyl methane 4,4′-diisocyanate, diphenylmethane-2,4′-diisocyanate or diphenylmethane-2,2′-diisocyanate, a mixture of these isomers (MDI), phenylene-1,3-diisocyanate or phenylene-1,4-diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), dianisidine diisocyanate (DADI), tetramethylene-1,4-diisocyanate, 2-methylpentamethylene-1,5-diisocyanate, hexamethylene-1,6-diisocyanate (HDI), 2,2,4-trimethylhexamethylene-1,6-diisocyanate, 2,4,4-trimethylhexamethylene-1,6-diisocyanate, a mixture of these isomers (TMDI), decamethylene-1,10-diisocyanate, dodecamethylene-1,12-diisocyanate, cyclohexane-1,3-diisocyanate, cyclohexane-1,4-diisocyanate, 1-methyl-2,4-diisocyanatocyclohexane, 1-methyl-2,6-diisocyanatocyclohexane, a mixture of these isomers (HTDI or H6TDI), 1-isocyanato-3,3,5-trimethyl-5-isocyanatomethylcyclohexane (isophorone diisocyanate or IPDI), perhydro (diphenylmethane)-2,4′-diisocyanate, perhydro (diphenylmethane)-4,4′-diisocyanate (HMDI or H12MDI), 1,4-diisocyanato-2,2,6-trimethylcyclohexane (TMCDI), 1,3-bis(isocyanatomethyl)cyclohexane, 1,4-bis(isocyanatomethyl)cyclohexane, m-xylylene-diisocyanate (m-XDI), p-xylylene-diisocyanate (p-XDI), m-tetramethylxylylene-1,3-diisocyanate, m-tetramethylxylylene-1,4-diisocyanate (m-TMXDI), p-tetramethylxylylene-1,3-diisocyanate, p-tetramethylxylylene-1,4-diisocyanate (p-TMXDI), bis(1-isocyanato-1-methylethyl)-naphthalene and mixtures thereof. Particularly preferred is diphenylmethane-2,4′-diisocyanate, diphenylmethane-2,2′-diisocyanate, or a mixture of these isomers (MDI), with MDI being post preferred.

As for MDI, the following isomers or regioisomers of MDI are employed and form part of the mixture in which technical grade MDI normally occurs:

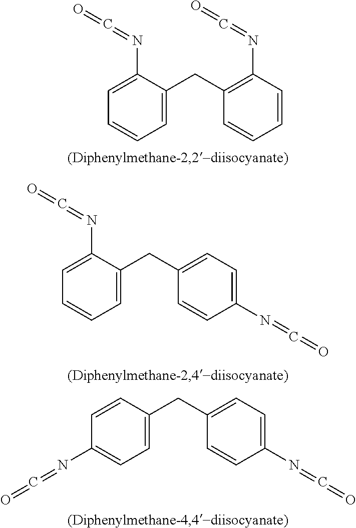 [SMILES: O=C=Nc1ccccc1Cc1ccccc1N=C=O ; O=C=Nc1ccc(Cc2ccccc2N=C=O)cc1 ; O=C=Nc1ccc(Cc2ccc(N=C=O)cc2)cc1]

Polymeric isocyanates according to the invention can be represented by the following general formula:

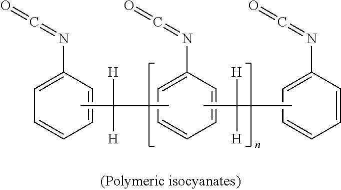

As used herein, a carbon nanotube (CNT) is to be understood in the usual skilled manner. A carbon nanotube having a single-wall is also referred to as a single-wall carbon nanotube (SWCNT). Such a single-wall carbon nanotube is an allotrope of carbon and can for example be seen as an intermediate between a fullerene cage and flat graphene, with diameters typically in the range of a nanometer. A single-wall carbon nanotube can be idealized as a cut-out from a two-dimensional hexagonal lattice of carbon atoms rolled up along one of the Bravais lattice vectors of the hexagonal lattice to form a hollow cylinder. In this construction, periodic boundary conditions are imposed over the length of this roll-up vector to yield a helical lattice of seamlessly bonded carbon atoms on the cylinder surface. A multi-wall carbon nanotube (MWCNT) is made of nested single-wall carbon nanotubes weakly bound together by van-der-Waals interactions in a tree ring-like structure. Multi-wall carbon nanotubes encompass double-wall and triple-wall carbon nanotubes.

In a coating system according to the present invention, parts (A) and (B) are physically separated from each other, i.e., there is no physical contact between them. Accordingly, part (A) and part (B) may be placed in two separate containers, e.g. part (A) is in a first container and part (B) is in a second container. The coating system according to the present invention may thus also be termed a two-component system, or a kit of parts, comprising parts (A) and (B). The physical separation of parts (A) and (B) may be achieved by storing parts (A) and (B) in two different containers, or in two different compartments of one container. The physical separation may in particular be such that no reaction between the at least one polyol comprised by part (A) and the at least one isocyanate comprised by part (B) can occur.

When parts (A) and (B) are mixed, or brought into contact with each other, the at least one polyol comprised by part (A) and the at least one isocyanate comprised by part (B) will react with each other to form a polyurethane which comprises urethane groups (—NH—(C═O)—O— groups). The coating systems according to the present invention may thus also be referred to as polyurethane coating systems. When the reaction between the at least one polyol comprised by part (A) and the at least one isocyanate comprised by part (B) as well as all other possible reactions between components of parts (A) and (B), potentially via intermediates, are finished, the mixture of parts (A) and (B) forms a coating. The end of those reactions can for example be determined by measuring the temperature of the mixture of parts (A) and (B). As soon as no change of temperature—in an otherwise isothermic environment—of the mixture of parts (A) and (B) can be observed anymore, the coating has formed. A coating is regularly formed within 24 h. Once the coating has formed, its properties can be determined according to protocols established in the art.

A coating formed from a coating system according to the present invention as described above, i.e., by mixing parts (A) and (B), has an electrical resistance of ≤80 kΩ (80,000 Ohm or less). Herein, the electrical resistance is measured according to DIN EN 61340-4-1:2016-04, “Standard test methods for specific applications-Electrical resistance of floor coverings and installed floors”.

A coating formed from a coating system according to the present invention as described above, i.e., by mixing parts (A) and (B), further has a bond strength of ≥1.5 MPa. Herein, the bond strength is measured according to DIN EN 1542:1999-07, “Products and systems for the protection and repair of concrete structures—Test methods—Measurement of bond strength by pull-off”.

Due to its low electrical resistance, a coating formed from the coating system according to the present invention has improved anti-static properties. Further, due to its high bond strength, a coating formed from the coating system according to the present invention has an improved adhesion to a substrate and in particular has an improved adhesion to a concrete substrate. Additionally, the coating system according to the present invention can do away with the requirement of an additional diffusion barrier layer. Without wishing to be bound to theory, it is assumed that the improved anti-static properties and the simultaneously improved bond strength are at least partly brought about by an orientation of the carbon nanotubes and/or an agglomeration thereof at the surface of the coating (surface effect).

Moreover, it has been found that carbon nanotubes can be distributed more uniformly in the coating system according to the present invention, more specifically in part (B) thereof. Further, the carbon nanotubes can be incorporated into the coating system according to the present invention and more specifically into part (B) thereof without experiencing a disadvantageously increased viscosity, i.e., the carbon nanotubes can be incorporated at reduced processing viscosity.

It is preferred for the coating system according to the present invention that the electrical resistance is ≤20 kΩ, more preferably ≤10 kΩ. With such a particularly low electrical resistance, a coating formed from the coating system can have particularly improved anti-static properties. However, reducing the electrical resistance to almost zero would potentially require the addition of excessive and hence uneconomic amounts of carbon nanotubes. Therefore, it is preferred for the coating system according to the present invention that the electrical resistance is ≥0.1 kΩ, more preferably ≥1 kΩ2. Accordingly, it is particularly preferred for the coating system according to the present invention that the electrical resistance is in the range of >0.1 kΩ to ≤80 kΩ, more preferably in the range of ≥0.1 kΩ to ≤20 kΩ. and still more preferably in the range of ≥1 kΩ to ≤10 kΩ.

It is preferred for the coating system according to the present invention that the bond strength is ≥3.0 MPa. With such a particularly high bond strength, a coating formed from the coating system can have a particularly improved adhesion to substrates. However, an almost unlimited increase of the bond strength would potentially require the use of specifically designed and hence costly and uneconomic polyols in part (A) and/or isocyanates in parts (B). Therefore, it is preferred for the coating system according to the present invention that the bond strength is ≤10.0 MPa, more preferably ≤5.0 MPa. Accordingly, it is particularly preferred for the coating system according to the present invention that the bond strength is in the range of ≥1.5 MPa to ≤10.0 MPa and still more preferably in the range of ≥3.0 MPa to ≤5.0 MPa.

Surprisingly it has also been found that the electrical resistance of the coating obtained with the coating system according to the invention decreases in the order polymeric aromatic isocyanate>carbodiimide-modified aromatic isocyanate≈monomeric aromatic isocyanate as a component of part (B). In other words, a coating resulting from the use of polymeric aromatic isocyanate in part (B) of the coating system according to the invention shows a higher electrical resistance than a coating which results from the use of carbodiimide-modified aromatic isocyanate or monomeric aromatic isocyanate in part (B); coatings obtained by employing carbodiimide-modified aromatic isocyanate in part (B) have a similar (same order of magnitude) electrical resistance as those obtained by employing monomeric aromatic isocyanate in part (B), as is indicated by the symbol “≈” hereinbefore.

It is preferred for the coating system according to the present invention that the at least one isocyanate is a carbodiimide-modified isocyanate. A carbodiimide-modified isocyanate (compound) results from the conversion of two isocyanate groups in an isocyanate compound of general formula O═C═N—R—N═C═O, with R being e.g. selected from the group consisting of alkylene and arylene, which may be substituted by one or more isocyanate groups, as in a polymeric isocyanate of the following formula

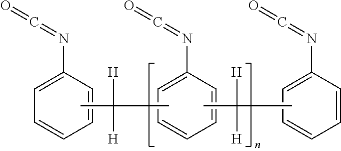

to a carbodiimide of the following general formula

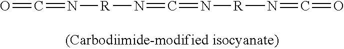

with loss of carbon dioxide, usually under catalysis (e.g. catalyzed by a phosphine oxide of general formula R₁R₂R₃PO with substituents R₁R₂R₃ being independently selected from the group consisting of alkyl and aryl, wherein said substituents can be the same or different or two substituents can form a ring), as is well-known in the art; this leaves a carbodiimide unit in the backbone and two free terminal isocyanate groups, i.e. one isocyanate group at either end of the respective isocyanate compound obtained, as is shown by the general formula for a carbodiimide-modified isocyanate above.

In case of the isocyanate being MDI, R represents symmetrical or asymmetrical substitution patterns at the two phenylene rings in ortho- or para-position (with a small to negligible proportion of substitution in meta-position), as is shown by the formulas for diphenyl methane 4,4′-diisocyanate, diphenylmethane-2,4′-diisocyanate and diphenylmethane-2,2′-diisocyanate, all of which are depicted hereinbefore.

When the at least one isocyanate is a carbodiimide-modified isocyanate, the electrical resistance can be further lowered and hence the anti-static properties can be further improved. Without wishing to be bound to theory, it is assumed that the improved electrical resistance is at least partly brought about by delocalized π-electrons in the carbodiimide-unit of the carbodiimide-modified isocyanate. It is preferred that the carbodiimide-modified isocyanate is used in part (B) together with a fatty acid ester-based plasticizer, i.e., that part (B) comprises a fatty acid ester-based plasticizer, which can lead to even further improved anti-static properties of the resulting coating.

It is possible to use polymeric aromatic isocyanate in admixture or blended with monomeric and/or carbodiimide-modified aromatic isocyanate. However, by increasing the proportion of polymeric aromatic isocyanate of the overall content of aromatic isocyanates, the effect of decreasing the electrical resistance is less pronounced or reduced. This is because the presence of a monomeric and/or carbodiimide-modified aromatic isocyanate in a part (B) composition lowers the electrical resistance of a coating obtained by using such part (B) composition more than the presence of a polymeric aromatic isocyanate. It is preferred that the polymeric isocyanate is used in part (B) together with a fatty acid ester-based plasticizer, i.e., that part (B) comprises a fatty acid ester-based plasticizer, which can lead to even further improved anti-static properties of the resulting coating. It is further preferred that the polymeric isocyanate is used in part (B) together with a quaternary ammonium salt, i.e., that part (B) comprises a quaternary ammonium salt, which can also lead to even further improved anti-static properties of the resulting coating.

It is particularly preferred for the coating system according to the present invention that the at least one isocyanate is a monomeric isocyanate. When the at least one isocyanate is a monomeric isocyanate, the carbon nanotubes can be even more uniformly distributed in part (B) of the coating system and can be distributed at reduced processing viscosity. It is preferred that the monomeric isocyanate is used in part (B) together with a fatty acid ester-based plasticizer, i.e., that part (B) comprises a fatty acid ester-based plasticizer, which can lead to even further improved anti-static properties of the resulting coating. It is further preferred that the monomeric isocyanate is used in part (B) together with a quaternary ammonium salt, i.e., that part (B) comprises a quaternary ammonium salt, which can also lead to even further improved anti-static properties of the resulting coating. Without wishing to be bound to theory, it is assumed that the improved anti-static properties and the simultaneously improved bond strength observed when using a monomeric isocyanate in part (B) of an inventive coating system are at least partly brought about by an improved dispersion of the carbon nanotubes in part (B) of the system and by a subsequent orientation of the carbon nanotubes and/or an agglomeration thereof at the surface of the coating formed from the coating system, i.e., by a subsequent surface effect of the previously dispersed carbon nanotubes.

For the preferred case that the at least one isocyanate is a monomeric isocyanate which is furthermore the only isocyanate in part (B), it is preferred that the coating system according to the present invention does not comprise a fatty acid ester-based plasticizer and does more preferably not comprise any plasticizer. The absence of a fatty acid ester-based plasticizer and in particular the absence of any plasticizer in such a coating system avoids an undesired increase of the electrical resistance.

It is preferred for the coating system according to the present invention that the at least one isocyanate is an aromatic isocyanate. When the at least one isocyanate is an aromatic isocyanate, the electrical resistance can be further lowered and hence the anti-static properties can be further improved. Without wishing to be bound to theory, it is assumed that the improved electrical resistance is at least partly brought about by delocalized T-electrons in the aromatic unit of the aromatic isocyanate. Additionally, aromatic isocyanates are often less expensive than aliphatic isocyanates so that the use of an aromatic isocyanate can improve the cost efficiency of the coating system according to the present invention. It is particularly preferred that the aromatic isocyanate is MDI, more preferably carbodiimide-modified MDI and/or monomeric MDI.

It is preferred for the coating system according to the present invention that part (B) comprises two different isocyanates. When part (B) comprises two different isocyanates the carbon nanotubes can be even more uniformly distributed in part (B) of the coating system and can be distributed at a reduced processing viscosity. It is more preferred for the coating system according to the present invention that the two different isocyanates are two different aromatic isocyanates. It is even more preferred for the coating system according to the present invention that the two different isocyanates are one monomeric aromatic isocyanate and one carbodiimide-modified aromatic isocyanate. Again, the carbon nanotubes can be even more uniformly distributed in part (B) of the coating system and can be distributed at a reduced processing viscosity. In particular, the monomeric aromatic isocyanate allows for a better distribution of the carbon nanotubes and a reduced processing viscosity. At the same time, the electrical resistance can be further lowered and hence the anti-static properties can be further improved. Without wishing to be bound to theory, it is assumed that the improved electrical resistance is at least partly brought about by delocalized T-electrons in the aromatic units of the two aromatic isocyanates, in particular by the aromatic units in the monomeric aromatic isocyanate and carbodiimide-modified aromatic isocyanate which is hence assumed to particularly contribute to lowering the electrical resistance.

It is preferred for the coating system according to the present invention that part (B) comprises monomeric aromatic isocyanate, preferably monomeric MDI or TDI, more preferably monomeric MDI. With such a mixture of isocyanates in part (B) further improved anti-static properties can be achieved.

It is preferred for the coating system according to the present invention that part (B) comprises carbodiimide-modified aromatic isocyanate, preferably carbodiimide-modified MDI or TDI, more preferably carbodiimide-modified MDI. With such a mixture of isocyanates in part (B) further improved anti-static properties can be achieved.

It is preferred for the coating system according to the present invention that part (B) comprises monomeric aromatic isocyanate and carbodiimide-modified aromatic isocyanate, preferably monomeric MDI and carbodiimide-modified MDI or monomeric TDI and carbodiimide-modified TDI, more preferably monomeric MDI and carbodiimide-modified MDI. With such a mixture of isocyanates in part (B) further improved anti-static properties can be achieved.

It is preferred for the coating system according to the present invention that part (B) comprises carbodiimide-modified aromatic isocyanate and polymeric aromatic isocyanate, preferably carbodiimide-modified MDI and polymeric MDI or carbodiimide-modified TDI and polymeric TDI, more preferably carbodiimide-modified MDI and polymeric MDI. With such a mixture of isocyanates in part (B) further improved anti-static properties can be achieved. It is preferred for the coating system according to the present invention that part (B) comprises monomeric aromatic isocyanate and polymeric aromatic isocyanate, preferably monomeric MDI and polymeric MDI or monomeric TDI and polymeric TDI, more preferably monomeric MDI and polymeric MDI. With such a mixture of isocyanates in part (B) further improved dispersibility of the carbon nanotubes in part (B) can be achieved.

It is preferred for the coating system according to the present invention that part (B) comprises carbodiimide-modified aromatic isocyanate, preferably carbodiimide-modified MDI or TDI, more preferably carbodiimide-modified MDI, and a plasticizer, preferably a fatty acid ester-based plasticizer. With such a composition comprised by part (B) further improved workability, e.g. reduced viscosity can be achieved.

It is preferred for the coating system according to the present invention that part (B) comprises polymeric aromatic isocyanate, preferably polymeric MDI or TDI, more preferably polymeric MDI, and a plasticizer, preferably a fatty acid ester-based plasticizer. With such a composition comprised by part (B) further improved workability, e.g. reduced viscosity can be achieved.

It is preferred for the coating system according to the present invention that part (B) comprises monomeric aromatic isocyanate, preferably monomeric MDI or TDI, more preferably monomeric MDI, and a plasticizer, preferably a fatty acid ester-based plasticizer. With such a composition comprised by part (B) further improved workability, e.g. reduced viscosity can be achieved.

It is preferred for the coating system according to the present invention that part (B) comprises carbodiimide-modified aromatic isocyanate, preferably carbodiimide-modified MDI or TDI, more preferably carbodiimide-modified MDI, and a quaternary ammonium salt. With such a composition comprised by part (B) further improved anti-static properties can be achieved.

It is preferred for the coating system according to the present invention that part (B) comprises polymeric aromatic isocyanate, preferably polymeric MDI or TDI, more preferably polymeric MDI, and a quaternary ammonium salt. With such a composition comprised by part (B) further improved anti-static properties can be achieved.

It is preferred for the coating system according to the present invention that part (B) comprises monomeric aromatic isocyanate, preferably monomeric MDI or TDI, more preferably monomeric MDI, and a quaternary ammonium salt. With such a composition comprised by part (B) further improved anti-static properties can be achieved.

It is preferred for the coating system according to the present invention that the carbon nanotubes are single-wall carbon nanotubes. The dispersibility of single-wall carbon nanotubes in part (B) is usually better than the dispersibility of multi-wall carbon nanotubes, leading to a better distribution of the carbon nanotubes in part (B). Also, multi-wall carbon nanotubes usually increase the processing viscosity of the carbon nanotubes in part (B) so that single-wall carbon nanotubes are also preferred from the viewpoint of a reduced processing viscosity.

It is preferred for the coating system according to the present invention that part (A) comprises Ca(OH)₂, preferably ≥20 wt. % Ca(OH)₂ based on the total weight of part (A). When parts (A) and (B) of the coating system according to the present invention are mixed to form a coating, part (A) and part (B) react with each other. Foremost, the at least one polyol in part (A) and the at least one isocyanate in part (B) react with each other to form polyurethane. Additionally, the isocyanate in part (B) can react with water (H₂O), especially with water optionally comprised by part (A), to give a urea group (—NH—C(═O)—NH— group; which is then present in the final coating) and carbon dioxide (CO₂). Produced CO₂ can lead to an undesired foaming of the coating, but the Ca(OH)₂ acts as a CO₂-scavenger and reacts with the CO₂ to yield CaCO₃ and H₂O. In this way, the Ca(OH)₂ preferably comprised by part (A) can prevent an undesired foaming of the coating. This effect is particularly pronounced when the Ca(OH)₂ is more preferably comprised by part (A) in an amount of ≥20 wt. %, wherein the weight percentage is calculated based on the total weight of part (A).

It is preferred for the coating system according to the present invention that part (A) comprises particles of at least one basic metal compound independently selected from the group consisting of basic metal oxide compounds and basic metal hydroxide compounds, and at least one chelating agent comprising at least two functional groups capable of binding to a cation of said metal. The basic metal compound is preferably selected from calcium oxide, magnesium oxide, calcium hydroxide and magnesium hydroxide, more preferably from calcium oxide and calcium hydroxide, and is most preferably calcium oxide. The presence of the basic metal compound prevents the formation of bubbles or blisters in a coating from the coating composition according to the present invention, particularly on the surface of the coating, by capturing or quenching CO₂ which may be generated by the reaction of isocyanate compounds with water as described above. The chelating agent is preferably selected from amino acids, particularly naturally occurring amino acids, more preferably proteinogenic amino acids, polyphosphonic acids including diphosphonic acids, triphosphonic acids, tetraphosphonic acids and pentaphosphonic acids, phosphoric acids, phosphonic acids, sulfonic acids including monosulfonic acids having at least one further functional group selected from the group consisting of amino and hydroxy, disulfonic acids and polysulfonic acids, superplasticizers, carboxylic esters, carboxylic anhydrides, polyhydroxy carboxylic acids, carboxylic acids, polycarboxylic acids, such as e.g. dicarboxylic acids, tricarboxylic acids, tetracarboxylic acids and polycarboxylic acids, bidentate chelating agents, such as e.g. acetylacetone (acac), ethylenediamine (en), oxalate (ox), tartrate (tart), dimethylglyoxime (dmg), 8-hydroxychinoline (oxin), 2,2′-bipyridine (bpy), 1,10-phenanthroline (phen), dimercaptosuccinic acid (DMSA) and 1,2-bis(diphenylphosphino) ethane, tridentate chelating agents, such as e.g. 2-(2-aminoethylamino) ethanol (AEEA), diethylenetriamine (dien), iminodiacetate (ida) and citrate (cit), tetradentate chelating agents, such as e.g. triethylenetetramine (trien, TETA), triaminotriethylamin (tren), nitrilotriacetate (nta), bis(salicylidene)ethylenediamine (salen), pentadentate chelating agents, such as e.g. ethylenediaminetriacetate (ted), hexadentate chelating agents, such as e.g. ethylenediaminetetraacetate (EDTA), octadentate chelating agents, such as e.g. diethylenetriaminepentaacetate (DTPA) and 1,4,7,10-tetraazacyclododecane-1,4,7,10-tetraacetate (DOTA), and decadentate chelating agents, such as e.g. triethylenetetraminehexaacetate (TTHA).

It Is preferred for the coating system according to the present invention that part (A) is an aqueous emulsion, i.e., an emulsion of the at least one polyol in water. In the aqueous emulsion the at least one polyol comprised by part (A) can be stored in a safe manner, and its concentration can be easily adjusted as needed. Further, optional additional components of part (A), for example a CO₂-scavenger like Ca(OH)₂, can be easily dispersed in part (A).

It is preferred for the coating system according to the present invention that part (A) comprises a source of chemically bound water to take part in a urea-forming reaction. As opposed to physically bound water, the term chemically bound water means water that is bound in crystalline form, for example in ettringite, calcium silicate hydrate, aluminium hydroxide, zeolites, and the like. These materials may also be used in combination with each other and/or in combination with CO₂ scavengers, more preferred in combination with Ca(OH)₂.

Preferred for the composition of part (B) is a content of aliphatic isocyanate(s) in the range of from 0% to 100% by weight, based on the total weight of part (B) (corresponding to a range of from 0% to 70% by weight, based on the total weight of the coating system) and/or a content of aromatic isocyanate(s) in the range of from 0% to 80% by weight, based on the total weight of part (B) (corresponding to a range of from 0% to 60% by weight, based on the total weight of the coating system).

As for the aromatic isocyanate(s) in part (B), it is preferred to have a content of carbodiimide modified aromatic isocyanate(s) in the range of from 0% to 90% by weight, based on the total weight of part (B) (corresponding to a range of from 0% to 60% by weight, based on the total weight of the coating system), a content of polymeric aromatic isocyanate(s) in the range of from 0% to 75% by weight, based on the total weight of part (B) (corresponding to a range of from 0% to 50% by weight, based on the total weight of the coating system), and/or a content of monomeric aromatic isocyanate(s) in the range of from 0% to 90% by weight, based on the total weight of part (B) (corresponding to a range of from 0% to 60% by weight, based on the total weight of the coating system).

The aforementioned weight percentage ranges apply particularly to those coating systems and/or compositions of part (B) in which the aromatic isocyanate is MDI, particularly polymeric MDI, carbodiimide-modified MDI and/or monomeric MDI, preferably carbodiimide-modified MDI and/or monomeric MDI.

The aforementioned weight percentage ranges also apply particularly to those coating systems and/or compositions of part (B) in which the aromatic isocyanate is TDI, particularly polymeric TDI, carbodiimide-modified TDI and/or monomeric TDI, preferably carbodiimide-modified TDI and/or monomeric TDI.

It is preferred for the coating system according to the present invention that the coating system does not comprise an amine compound. An amine compound (especially a primary amine having an —NH₂ group and/or a secondary amine having a —NHR group with R being a hydrocarbon group such as alkyl, alkenyl and alkynyl) may interfere in the reaction between the at least one polyol comprised by part (A) and the at least one isocyanate comprised by part (B) and may in particular react itself with the isocyanate comprised by part (B). Such an interference may reduce the bond strength of the formed coating. Hence, it is preferred that no amine compound (or amine) is present in the coating system according to the present invention.

It is preferred for the coating system according to the present invention that the coating system does not comprise an epoxy compound. An epoxy compound may interfere in the reaction between the at least one polyol comprised by part (A) and the at least one isocyanate comprised by part (B) and may in particular react itself with the polyol comprised by part (A). Such an interference may reduce the bond strength of the formed coating. Hence, it is preferred that no epoxy compound is present in the coating system according to the present invention.

Subject of the invention is also a coating prepared from a coating system according to the present invention by mixing parts (A) and (B). The preferred embodiments of the coating system described herein including the claims are likewise preferred for this coating in an analogous manner. Due to its low electrical resistance, such a coating can have improved anti-static properties, and due to its high bond strength, such a coating can have an improved adhesion to a substrate, in particular to a concrete substrate.

Subject of the invention is also the use of a coating system according to the present invention for coating a substrate. The substrate is preferably a concrete substrate. The preferred embodiments of the coating system described herein including the claims are likewise preferred for the inventive use in an analogous manner. The use according to the present invention yields a coated substrate, or a substrate having a coating. Due to the high bond strength of the coating, the adhesion between the substrate and the coating can be improved. Further, due to low electrical resistance of the coating, the substrate may advantageously be used in environments requiring anti-static properties, especially where flammable substances are present. Additionally, due to the simultaneously low electrical resistance and high bond strength of the coating, no further coating layer such as a diffusion barrier layer needs to be applied.

The coating system according to the present invention can thus be used for instance for flooring, coating a wall or ceiling, creating a (waterproof) membrane, coating truck beds and loading areas in vessels such as cars, trucks, railway wagons and carriages, and marine vessels such as ferries and ships, and aircraft. Particularly advantageous are the aforementioned applications in connection with the loading, reloading, storage and/or transportation of dangerous goods, particularly flammable goods.

Subject of the invention is also a coating method, comprising the steps of
(i) providing a substrate,
(ii) mixing of parts (A) and (B) of a coating system according to the present invention, and
(iii) applying the mixture obtained in step (ii) onto the substrate.

The substrate is preferably concrete, e.g. a concrete slab or concrete surface. The preferred embodiments of the coating system described herein including the claims are likewise preferred for the inventive coating method in an analogous manner. The coating method according to the present invention provides a coating which has improved anti-static properties as well as improved adhesion to a substrate, in particular to a concrete substrate. Additionally, because of its simultaneously improved anti-static properties and adhesion to a substrate, the coated substrate obtained by the coating method according to the present invention does not require an additional diffusion barrier layer. Moreover, before step (ii), part (B) of the coating system is regularly prepared by mixing the at least one isocyanate and the carbon nanotubes. It has been found that in the coating method according to the present invention, the carbon nanotubes are distributed more uniformly in part (B). Further, the carbon nanotubes are incorporated into part (B) at a reduced processing viscosity.

### EXAMPLES

### Methods

Herein, the electrical resistance is measured according to DIN EN 61340-4-1:2016-04. More specifically, a copper strip is glued in the middle of an approx. 0.24 m² (40×60 cm²) Pavatex panel so that it overlaps approx. 5 cm inwards and outwards. Afterwards, MasterTop P 687 WAS conductive varnish (consumption 24 g per panel) is rolled on in a criss-cross pattern. After drying overnight at room temperature, the leakage resistance of the panel can be measured which shall be <10 kΩ. The Pavatex panel prepared in this way is sealed all around with a pre-laying tape so that no material can leak out. Parts (A) and (B) of the to-be-tested coating system are weighed out with the appropriate mixing ratio and are homogenized well with a wooden spatula. The resulting mixture is applied evenly to the conductive varnish by means of a toothed squeegee. The specimen is then cured on a horizontal surface for 24 h at room temperature. The electrical resistance is then measured using a Unilap ISO as an appropriate testing device. The defined standard conditions for this measurement are 23 °C and 50±10% humidity. The measured resistance value is read on the display of the measuring device and is then documented. Twenty (20) measurements are taken at different points per sample plate so that an average value can be determined from this. The thereby determined electrical resistance is reported in Ohm ((2). However, if the determined value exceeds 2.999 GΩ, the discharge capacity is too low and is assessed as a faulty measurement.

Herein, the bond strength is measured according to DIN EN 1542:1999-07. More specifically, the surface of a concrete panel of 40×40 cm is blasted to be fat-free, dry and smooth. Thereafter the surface of the concrete panel is coated with a coating prepared from the exemplified coating systems by mixing parts (A) and (B) thereof. On top thereof, MasterSeal M 790AS is applied in an amount of 0.8 kg/m² as a body coat. Four annular grooves are formed in the coated concrete panel using drilling heads each having a diameter of 5 cm. Four threaded punches are glued to the annular grooves using a two-component epoxy resin as an adhesive. The thereby produced specimen is allowed to dry for seven days (at standard climate, 23 °C, 50% relative humidity). Afterwards, a testing device (Freundl F 20+5 Easy DM 2020 0-20 kN) is screwed onto the threads of the punches. The motor of the testing device is started, and the device pulls the punches off from the coated concrete panel at a defined force of 6 kN. From the given diameter of the punches and the force at complete pull-off of the punches, the bond strength is determined and is reported in N/mm² or MPa.

### Example 1

The following composition was used to produce a part (B) of an inventive coating system:

| | | Composition |
|---|---|---|
| | | (parts by |
| Trade name | Chemical characterization | weight) |
| Lupranat MM 103 | Carbodiimide-modified MDI | 72.90 |
| Lupranat M 20 R | Polymeric MDI | 12.80 |
| Tuball Matrix 202 | Single-wall carbon nanotubes (CNT) | 1.10 |
| Oxfilm 351 | Fatty acid ester-based plasticizer | 13.20 |
| | | 100.0 (total) |

The isocyanates Lupranat MM 103 and Lupranat M 20 R were mixed in a mixer (dissolver) under nitrogen atmosphere and then stirred for 5 min at approx. 500 rpm. Subsequently, the carbon nanotubes Tuball Matrix 202 were added and the composition was stirred for another 5 min at 700 rpm. Subsequently, the carbon nanotubes were uniformly dispersed in the composition by stirring at approx. 2000 rpm until a paste-like consistency was obtained (obtained after 5 min). The stirring speed was then increased to 3000 rpm, and the stirring was continued for another 10 to 15 min. The stirring speed was thereafter lowered down to 1200 rpm, and the stirring was continued at 1200 rpm until a gel-like consistency was obtained (obtained after 10 min). Next, the fatty acid ester-based plasticizer Oxfilm 351 was added to the composition which was finally stirred at 800 to 1000 rpm for 5 min to give part (B).

Part (B) was then mixed with a polyol-containing standard part (A) of a MasterSeal P770 two-component polyurethane system in a weight ratio of part (A):part (B)=100:125. The electrical resistance of the resulting coating was determined as described herein and was found to be 9.8 kΩ (9,800 Ohm). The bond strength (sometimes also referred to as adhesive strength or pull-off strength) of the resulting coating was determined as described herein and was found to be 3.5 MPa (N/mm²).

Example 1 demonstrates that the combined use of a carbodiimide-modified MDI and a polymeric MDI in part (B) of an inventive coating system simultaneously leads to an improved electrical resistance and an improved bond strength.

### Example 2

The following composition was used to produce a part (B) of an inventive coating system:

| | | Composition |
|---|---|---|
| | | (parts by |
| Trade name | Chemical characterization | weight) |
| Lupranat MI | Monomeric MDI (2,4′MDI and 4,4′MDI | 72.90 |
| | in a weight ratio of 50/50) | |
| Lupranat M 20 R | Polymeric MDI | 12.80 |
| Tuball Matrix 202 | Single-wall carbon nanotubes (CNT) | 1.10 |
| Oxfilm 351 | Fatty acid ester-based plasticizer | 13.20 |
| | | 100.0 (total) |

The part (B) was produced in the same manner as in Example 1 except for using Lupranat MI instead of Lupranat MM 103. Thereafter a coating was prepared and the electrical resistance thereof was determined also in the same manner as in Example 1. As a result, an electrical resistance of 16 kΩ (16,000 Ohm) was determined. Further, the bond strength of the resulting coating was determined as described herein and was found to be 3.3 MPa (N/mm²).

Example 2 demonstrates that the use of a monomeric MDI in part (B) of an inventive coating system simultaneously leads to an improved electrical resistance and an improved bond strength.

### Comparative Example 1

The following composition was used to produce a part (A) of a comparative coating system:

| | | Composition |
|---|---|---|
| Trade name | Chemical characterization | (parts by weight) |
| P 770 PTA Standard | | 99.7 |
| Tuball Matrix 202, 10% in | 10 wt. % single-wall carbon nanotubes | 0.3 |
| Disflamoll DPK | (CNT) in flame retardant (cresyl | |
| | diphenyl phosphate) | |
| | | 100.0 |

A polyol-containing standard part (A) of a MasterSeal P770 two-component polyurethane system (“P 770 PTA”) was added to a mixer and was stirred at approx. 600 rpm. Thereafter, Tuball Matrix 202, 10% in Disflamoll DPK, was added as carbon nanotubes and mixed into part (A) at approx. 700 rpm. Next, the carbon nanotubes were dispersed at approx. 2000 rpm. The rotational speed was increased during the dispersing process to 3000 rpm, and it was dispersed for in total approx. 30 min until a gel-like consistency is achieved. At this stage the mixer was slowed down to 1200 rpm, and the dispersing process was then stopped.

The produced part (A) showed decomposition and was inhomogeneous. Part (A) was further mixed with an isocyanate-containing standard part (B) of a MasterSeal P770 two-component polyurethane system in a weight ratio of part (A):part (B)=100:125. The electrical resistance of the resulting coating was determined as described herein and was found to be >2,999 GΩ (>2.9*1012 Ohm). The bond strength of the resulting coating was determined as described herein and was found to be 3.5 MPa (N/mm²).

Additionally, it was tried to stabilize and to homogenize the produced part (A) by adding 1 wt. % Byk P 104 S as a dispersing additive. However, no improvement was achieved.

### Comparative Example 2

The following composition was used to produce a part (A) of a comparative coating system:

| | | Composition |
|---|---|---|
| Trade name | Chemical characterization | (parts by weight) |
| P 770 PTA Standard | | 99.7 |
| Tuball Matrix 202, 5% in | 5 wt. % single-wall carbon nanotubes | 0.3 |
| Novares LA 700 | (CNT) in modifier (copolymerisation | |
| | product from unsaturated aromatic | |
| | C₉-/C₁₀-hydrocarbons with phenol). | |
| | | 100.0 |

The part (A) was prepared in the same manner as in Comparative Example 1 except for using Tuball Matrix 202, 5% in Novares LA 700, as carbon nanotubes. The produced part (A) showed decomposition and was inhomogeneous. A coating was prepared in the same manner as in Comparative Example 1, and the electrical resistance was also determined in the same manner as in Comparative Example 1. As a result, an electrical resistance of >2,999 GΩ (>2.9*1012 Ohm) was determined. Further, the bond strength of the resulting coating was determined as described herein and was found to be 3.1 MPa (N/mm²).

Like in Comparative Example 1, it was also tried to stabilize and to homogenize the produced part (A) by adding 1 wt. % Byk P 104 S as a dispersing additive. However, no improvement was achieved.

### Example 3 and Comparative Examples 3 and 4

The following compositions were used to produce a respective part (B) of an inventive coating system:

| | Comparative | | Comparative |
|---|---|---|---|
| | Example 3 | Example 3 | Example 4 |
| | (parts by | (parts by | (parts by |
| Trade name | weight) | weight) | weight) |
| Lupranat M 20 R | 98.90 | | |
| Lupranat MI | | 98.90 | |
| Lupranat MM 103 | | | 98.90 |
| Tuball Matrix 202 | 1.10 | 1.10 | 1.10 |
| Total | 100.00 | 100.00 | 100.00 |

Part (B) was prepared in a manner analogous to Example 1. The resulting part (B) was then mixed with a polyol-containing standard part (A) of a two-component polyurethane system (Mseal P 770 PTA Standard) in a weight ratio of part (A):part (B)=100:125. For obtaining a final coating, Mseal P 770 PTA Standard was applied in an amount of 0.25 to 0.4 kg/m²

The electrical resistance of the resulting coating was determined as described herein after 7 d. The determined electrical resistances are summarized in the following table:

| | Comparative | | Comparative |
|---|---|---|---|
| | Example 3 | Example 3 | Example 4 |
| Electrical resistance (R) | 280 kΩ | 13.7 kΩ | 50 kΩ |

As mentioned in the context of Example 1, Lupranat M 20 R used in Comparative Example 3 is a polymeric MDI and Lupranat MM 103 used in Comparative Example 4 is a carbodiimide-modified MDI. As mentioned in the context of Example 2, Lupranat MI used in Example 3 is a monomeric MDI (2,4 MDI and 4,4′MDI in a weight ratio of 50/50). As mentioned in the context of Example 1, Tuball Matrix 202 as used in Comparative Examples 3 and 4 and also in Example 3 is composed of single-wall carbon nanotubes (SCNT). From the determined electrical resistances, it is seen that the use of a monomeric MDI in part (B) of an inventive coating composition leads to particularly improved antistatic properties of the resulting coating. It is further seen that the electrical resistance drops in the order polymeric MDI>carbodiimide-modified MDI≈monomericMDI as a component of part (B). In other words, a coating resulting from the use of polymeric MDI in part (B) of the coating system shows a higher electrical resistance than a coating which results from the use of carbodiimide-modified MDI or monomeric MDI in part (B); coatings obtained by employing carbodiimide-modified MDI in part (B) have a similar (same order of magnitude) electrical resistance as those obtained by employing monomeric MDI in part (B), as is indicated by the symbol “≈” hereinbefore.

### Example 4 and Comparative Examples 5 and 6

The following compositions were used to produce a respective part (B) of an inventive coating system:

| | Comparative | | Comparative |
|---|---|---|---|
| | Example 5 | Example 4 | Example 6 |
| | (parts by | (parts by | (parts by |
| Trade name | weight) | weight) | weight) |
| Lupranat M 20 R | 82.00 | | |
| Lupranat MI | | 82.00 | |
| Lupranat MM 103 | | | 82.00 |
| Oxfilm 351 | 18.00 | 18.00 | 18.00 |
| Tuball Matrix 202 | 1.10 | 1.10 | 1.10 |
| Total | 101.10 | 101.10 | 101.10 |

Part (B) was prepared in a manner analogous to Example 1. The resulting part (B) was then mixed with a polyol-containing standard part (A) of a two-component polyurethane system (Mseal P 770 PTA Standard) in a weight ratio of part (A):part (B)=100:125. For obtaining a final coating, Mseal P 770 PTA Standard was applied in an amount of 0.25 to 0.4 kg/m²

The electrical resistance of the resulting coating was determined as described herein after 7 d. The determined electrical resistances are summarized in the following table:

| | Comparative | | Comparative |
|---|---|---|---|
| | Example 5 | Example 4 | Example 6 |
| Electrical resistance (R) | 1042 kΩ | 68.3 kΩ | 70 kΩ |

As mentioned in the context of Example 1, the material Oxfilm 351 additionally used in these (Comparative) Examples is a fatty acid ester-based plasticizer. It is seen that the use of such a plasticizer lowered the electrical resistance for the composition containing a monomeric MDI in part (B) as well as for the composition containing a carbodiimide-modified MDI in part (B). While the plasticizer slightly increased the electrical resistance of the composition containing a monomeric MDI in part (B), the same trend as previously is observed, namely that the electrical resistance drops in the order polymeric MDI>carbodiimide-modified MDI≈monomeric MDI as a component of part (B). In other words, a coating resulting from the use of polymeric MDI in part (B) of the coating system shows a higher electrical resistance than a coating which results from the use of carbodiimide-modified MDI or monomeric MDI in part (B); coatings obtained by employing carbodiimide-modified MDI in part (B) have a similar (same order of magnitude) electrical resistance as those obtained by employing monomeric MDI in part (B), as is indicated by the symbol “≈” hereinbefore.

### Examples 5 and 6 and Comparative Example 7

The following compositions were used to produce a respective part (B) of an inventive coating system:

| | | | Comparative |
|---|---|---|---|
| | Example 5 | Example 6 | Example 7 |
| | (parts by | (parts by | (parts by |
| Trade name | weight) | weight) | weight) |
| Lupranat M 20 R | 94.90 | | |
| Lupranat MI | | 94.90 | |
| Lupranat MM 103 | | | 94.90 |
| EFKA IO 6783 | 4.00 | 4.00 | 4.00 |
| (from BASF) | | | |
| Tuball Matrix 202 | 1.10 | 1.10 | 1.10 |
| Total | 100.00 | 100.00 | 100.00 |

Part (B) was prepared in a manner analogous to Example 1. The resulting part (B) was then mixed with a polyol-containing standard part (A) of a two-component polyurethane system (Mseal P 770 PTA Standard) in a weight ratio of part (A):part (B)=100:125. For obtaining a final coating, Mseal P 770 PTA Standard was applied in an amount of 0.25 to 0.4 kg/m²

The electrical resistance of the resulting coating was determined as described herein after 7 d. The determined electrical resistances are summarized in the following table:

| | | | Comparative |
|---|---|---|---|
| | Example 5 | Example 6 | Example 7 |
| Electrical resistance (R) | 727 kΩ | 10.9 kΩ | 43.5 kΩ |

The material EFKA IO 6783 additionally used in these (Comparative) Examples is composed of a liquid quaternary ammonium salt which acts as a conductive additive and lowers the electrical resistance in all cases. However, it is seen that the electrical resistance is particularly lowered when a carbodiimide modified MDI or a monomeric MDI is used as an isocyanate component in part (B) of the respective coating system. Moreover, once again the same trend as previously is observed, namely that the electrical resistance drops in the order polymeric MDI>carbodiimide-modified MDI≈monomeric MDI as a component of part (B). In other words, a coating resulting from the use of polymeric MDI in part (B) of the coating system shows a higher electrical resistance than a coating which results from the use of carbodiimide-modified MDI or monomeric MDI in part (B); coatings obtained by employing carbodiimide-modified MDI in part (B) have a similar (same order of magnitude) electrical resistance as those obtained by employing monomeric MDI in part (B), as is indicated by the symbol “≈” hereinbefore.

1. A coating system, comprising:
a part (A) comprising at least one polyol bearing two or more hydroxy groups, and
a part (B) comprising at least one isocyanate bearing two or more isocyanate groups and comprising carbon nanotubes,
wherein parts (A) and (B) are physically separated from each other, and
wherein a coating produced by mixing parts (A) and (B) has an electrical resistance of ≤80 k (2, measured according to DIN EN 61340-4-1:2016-04, and a bond strength of ≥1.5 MPa, measured according to DIN EN 1542:1999-07.

2. The coating system according to claim 1, wherein the electrical resistance is ≤20 kΩ.

3. The coating system according to claim 1, wherein the bond strength is ≥3.0 MPa.

4. The coating system according to claim 1, wherein the at least one isocyanate is a carbodiimide-modified isocyanate.

5. The coating system according to claim 1, wherein the at least one isocyanate is a monomeric isocyanate.

6. The coating system according to claim 1, wherein the at least one isocyanate is an aromatic isocyanate.

7. The coating system according to claim 1, wherein part (B) comprises two different isocyanates.

8. The coating system according to claim 7, wherein the two different isocyanates are one monomeric aromatic isocyanate and one carbodiimide-modified aromatic isocyanate.

9. The coating system according to claim 1, wherein the carbon nanotubes are single-wall carbon nanotubes.

10. The coating system according to claim 1, wherein part (A) comprises Ca(OH)₂, preferably ≥20 wt. % Ca(OH)₂ based on the total weight of part (A).

11. The coating system according to claim 1, wherein part (A) is an aqueous emulsion.

12. The coating system according to claim 1, wherein the coating system
(i) does not comprise an amine compound, and/or
(ii) does not comprise an epoxy compound.

13. A coating prepared from a coating system according to claim 1 by a process comprising the step of mixing parts (A) and (B).

14. Use of a coating system according to claim 1 for coating a substrate.

15. A coating method, comprising the steps of
(i) providing a substrate,
(ii) mixing of parts (A) and (B) of a coating system according to claim 1, and
(iii) applying the mixture obtained in step (ii) onto the substrate.
